(19) United States
(12) Patent Application Publication
(10) Pub. No.: US 2026/0228790 A1
(43) Pub. Date: Aug. 6, 2026

(54) MANAGEMENT SYSTEM BASED ON PRODUCT MODEL LIST

(71) Applicant: SEKORM ESERVICE CO., LTD., Shenzhen City (CN)

(72) Inventors: QING XIAO, Shenzhen City (CN); FANG LI, Shenzhen City (CN); CHUJUN HUANG, Shenzhen City (CN)

(73) Assignee: SEKORM ESERVICE CO., LTD., Shenzhen City (CN)

(21) Appl. No.: 19/538,956

(22) Filed: Feb. 12, 2026

Related U.S. Application Data
(63) Continuation of application No. PCT/CN2024/111250, filed on Aug. 9, 2024.

(30) Foreign Application Priority Data
Aug. 14, 2023 (CN) 202311021271.0

(51) Int. Cl. G06Q 30/0601; G06Q 10/0875

(52) U.S. Cl. CPC G06Q 30/06212; G06Q 10/0875; G06Q 30/0623; G06Q 30/0641

(57) ABSTRACT

The present invention relates to a management system based on a product model list, comprising: a first interactive interface and a first pop-up window. The first interactive interface comprises a search area, a first information display area and a service operation area. The service operation area comprises multiple different first order operation controls, each of which allows a user to perform an order operation. By setting multiple first order operation controls in the first interactive interface, the invention addresses the issue where models selected for different purposes are scattered in different places, only supporting the initiation of a single service and failing to achieve the connection between models and services. Moreover, the invention connects models and services added across various scenarios through the model list, enabling engineers to quickly initiate diversified services for a single BOM based on different R&D stages.

### CROSS-REFERENCE TO RELATED APPLICATIONS

The present application is a continuation of PCT Application No. PCT/CN2024/111250 filed on Aug. 9, 2024, which claims priority to a Chinese Patent Application No. 202311021271.0 filed on Aug. 14, 2023, the entire contents of which are incorporated herein by reference.

### TECHNICAL FIELD

The present invention relates to the technical field of e-commerce platforms, and more specifically, to a management system based on a product model list.

### DESCRIPTION OF RELATED ART

To enhance production efficiency, improve product quality, and manage project progress, engineers generate a series of related Bill of Materials (BOM lists). Depending on the project phase, engineers have varying requirements for these BOM lists. During the early stages of development, engineers typically search for part numbers in the BOM lists across different platforms to request samples or import the BOM lists to inquire about pricing and lead times. Later, when purchasing needs arise, they search for the part numbers again, add them to the cart, and proceed with bulk purchases.

However, the current approach presents the following issues:

Resource requests are fragmented across project phases. For example, if engineers need to request samples based on a BOM list, they must search for part numbers on a platform and submit an application. Later, if they require pricing or lead time inquiries, they must use another entry point—either through search or by importing a table—to request additional service resources for the same part numbers. This results in scattered resource requests that lack centralized management.

Project lists cannot establish a one-to-N relationship with resources. Based on project needs, engineers create their own list management sets. At different R&D stages, they form one-to-one relationships with the platform for single service resource requests. After receiving feedback from the platform, engineers evaluate and update their BOM lists accordingly. For subsequent project phase requirements, they must repeat the process by establishing new connections with the resource platform based on updated BOM lists, leading to a repetitive cycle of relationship establishment.

### BRIEF SUMMARY OF THE INVENTION

The technical problem to be solved by the present invention is to provide a management system based on a product model list.

The technical solution adopted by the present invention to solve the technical problem is to construct a management system based on a product model list, comprising: a first interactive interface and a first pop-up window;

The first interactive interface comprises: a search area, a first information display area, and a service operation area; the search area is configured to receive a user-input desired model, the first information display area displays product information of the desired model, and the service operation area is configured for a user to perform order operations for different needs and outputs the first pop-up window based on a user's order operation, wherein the first pop-up window displays the product information of the desired model triggered by the user's order operation;

The service operation area comprises: multiple different first order operation controls that can meet user needs, each of which is configured for a user to perform an order operation.

In the management system based on a product model list according to the present invention, the first pop-up window comprises: a second information display area, a purchase quantity input area, an open model list control, an add to list control, and a first settlement control; the management system further comprises: a second interactive interface;

The second information display area is configured to display the product information of the desired model;

The purchase quantity input area is configured for the user to input the purchase quantity of the desired model;

The open model list control is configured to enter the second interactive interface based on a user's triggering operation;

The add to list control is configured to add the desired model to the model list based on a user's triggering operation;

The first settlement control is configured to execute a settlement function for the desired model based on a user's triggering operation.

In the management system based on a product model list according to the present invention, the first interactive interface further comprises: a model list control;

The model list control is configured to display the quantity in the model list and enter the second interactive interface based on a user's triggering operation.

In the management system based on a product model list according to the present invention, after the add to list control receives a user's triggering operation, the first pop-up window is not displayed.

In the management system based on a product model list according to the present invention, the second interactive interface comprises: a list details display area and multiple different second order operation controls;

The list details display area is configured to display product information for all models;

Each second order operation control is configured for a user to perform an order operation.

In the management system based on a product model list according to the present invention, both the first order operation control and the second order operation control comprise: a bulk inquiry operation control, a delivery date inquiry operation control, a sample application operation control, an enterprise procurement operation control, a small-quantity quick purchase operation control, a model selector/comparison table operation control, and a product details page operation control.

In the management system based on a product model list according to the present invention, the second interactive interface further comprises: a second settlement control;

The second settlement control is configured to execute a settlement function for the selected model in the model list based on a user's triggering operation.

In the management system based on a product model list according to the present invention, the second interactive interface further comprises: a BOM list import control;

The BOM list import control is configured to import material information from a BOM list based on a user's triggering operation and display the product information of all models in the imported material information through the list details display area.

In the management system based on a product model list according to the present invention, the second interactive interface further comprises: a selection operation area;

The selection operation area is configured for a user to perform selection or deselection operation on models in the list details display area.

In the management system based on a product model list according to the present invention, the second interactive interface further comprises: a deletion control and a movement control;

The deletion control is configured for a user to perform a deletion operation on models in the list details display area;

The movement control is configured for a user to perform a movement operation on models in the list details display area.

The implementation of the management system based on a product model list according to the present invention provides the following beneficial effects: it comprises a first interactive interface and a first pop-up window; the first interactive interface comprises: a search area, a first information display area, and a service operation area; the service operation area comprises: multiple different first order operation controls, each of which allows a user to perform order operation. By configuring multiple first order operation controls in the first interactive interface, the present invention resolves the issue where models selected for different purposes are scattered in different places, only supporting a single service initiation, and failing to achieve connectivity between models and services. Moreover, the present invention utilizes the model list to connect models and services added across various scenarios, meeting engineers' needs to quickly initiate diversified services for a single BOM (Bill of Materials) based on different R&D stages.

### BRIEF DESCRIPTION OF THE SEVERAL VIEWS OF THE DRAWINGS

The present invention will be further described below in conjunction with the accompanying drawings and embodiments. The drawings include:

FIG. 1 is a schematic structural diagram of a first interactive interface provided by the present invention;

FIG. 2 is an example diagram of a model list entry provided by the present invention;

FIG. 3 is a schematic structural diagram of a second interactive interface provided by the present invention;

FIG. 4 is a diagram of a model list interface provided by the present invention;

FIG. 5 is a flowchart of a user order operation provided by the present invention.

### DETAILED DESCRIPTION OF THE INVENTION

The following will clearly and completely describe the technical solutions in the embodiments of the present invention with reference to the accompanying drawings. It is evident that the described embodiments are only a part of the embodiments of the present invention, rather than all of them. Based on the embodiments of the present invention, all other embodiments obtained by those of ordinary skill in the art without creative efforts shall fall within the protection scope of the present invention.

Specifically, the management system based on a product model list provided by the present invention includes: a first interactive interface 10 and a first pop-up window 15.

Wherein, the first interactive interface 10 includes: a search area 11, a first information display area 12, and a service operation area 13. The search area 11 is configured to receive a user-input desired model, the first information display area 12 displays the product information of the desired model, and the service operation area 13 is configured for the user to perform order operations for different needs and outputs the first pop-up window 15 based on the order operation executed by the user. The first pop-up window 15 displays the product information of the desired model based on the user's order operation. The service operation area 13 includes: multiple different first order operation controls that can meet user needs, each of which is configured for the user to perform an order operation.

In this embodiment, the search area 11 is set as the input interface provided to a user when searching for related models. When a user inputs the desired model, the system queries the relevant product information based on the desired model entered by the user in the search area 11 to retrieve the product information of the desired model. The product information of the desired model includes: the name of the desired model, description information of the desired model (such as type, series number, minimum packaging quantity, etc.), supplier information (such as supplier name), shipping location/expected delivery time, price, required quantity, settlement amount for a single model, etc.

Optionally, in this embodiment, the first order operation controls include but are not limited to: a batch quotation operation control, a delivery time inquiry operation control, a sample application operation control, an enterprise procurement operation control, a small-quantity quick purchase operation control, a model selector/comparison table operation control, and a product details page operation control.

In this embodiment, by setting multiple first order operation controls on the first interactive interface 10, various key services of the platform (such as batch quotation, delivery time inquiry, sample application, corporate procurement, small-quantity quick purchase, etc.) are connected based on the model as the carrier. In other words, after the user inputs the model to be searched, the system can display the relevant information of the model to the user. At the same time, the user can initiate different service requests directly on the first interactive interface 10, eliminating the previous scenario where models stored for different purposes were scattered across various places.

In this embodiment, the first pop-up window 15 includes: a second information display area, a purchase quantity input area, an open model list control, an add to list control, and a first settlement control. The management system further includes: a second interactive interface 20.

Specifically, the second information display area is configured to display product information of the desired model; the purchase quantity input area allows a user to input the purchase quantity of the desired model; the open model list control is configured to navigate to the second interactive interface 20 based on a user’s triggering operation; the add to list control is configured to add the desired model to the model list based on a user’s triggering operation; and the first settlement control is configured to execute the settlement function for the desired model based on a user’s triggering operation.

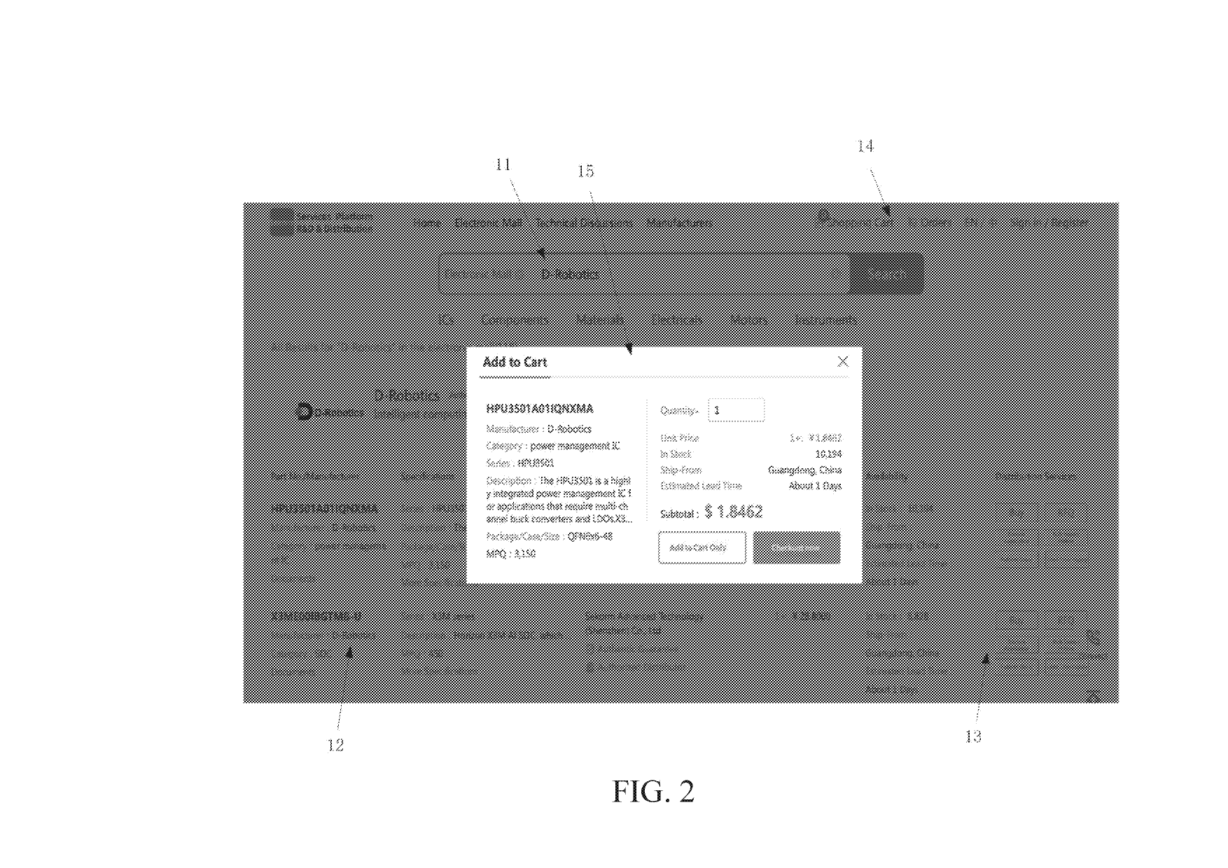

As shown in FIG. 2, when the user clicks any one of the multiple first order operation controls (FIG. 2 uses small-quick purchase as an example), the first pop-up window 15 appears. Simultaneously, the second information display area within the first pop-up window 15 displays details of the desired model, including its name, type, system number, minimum packaging quantity, purchase quantity, price, stock status (in stock, out of stock, etc.), shipping location, delivery lead time, and order amount. Moreover, a user can modify the purchase quantity in the purchase quantity input area.

In this embodiment, after the add to list control receives a user’s triggering operation, the first pop-up window 15 is no longer displayed.

Further, as shown in FIG. 2, when a user clicks the "Add to List" control, the TPSMA6L36A model is added to the model list, and the first pop-up window 15 is no longer displayed. This operation allows a user to store the desired models. When the user clicks the "Open Model List" control, they can directly access the second interactive interface 20. When the user clicks the "Immediate settlement" control, the system executes the checkout function for the TPSMA6L36A model, and the order is sent to the server. In this embodiment, after adding the TPSMA6L36A model to the model list via the "Add to List" control in the first pop-up window 15, the source of the model (e.g., Quick Purchase, Product Details Page, Bulk Inquiry, Delivery Query, etc.) is also labeled, achieving the purpose of allowing a user to trace the origin of stored models.

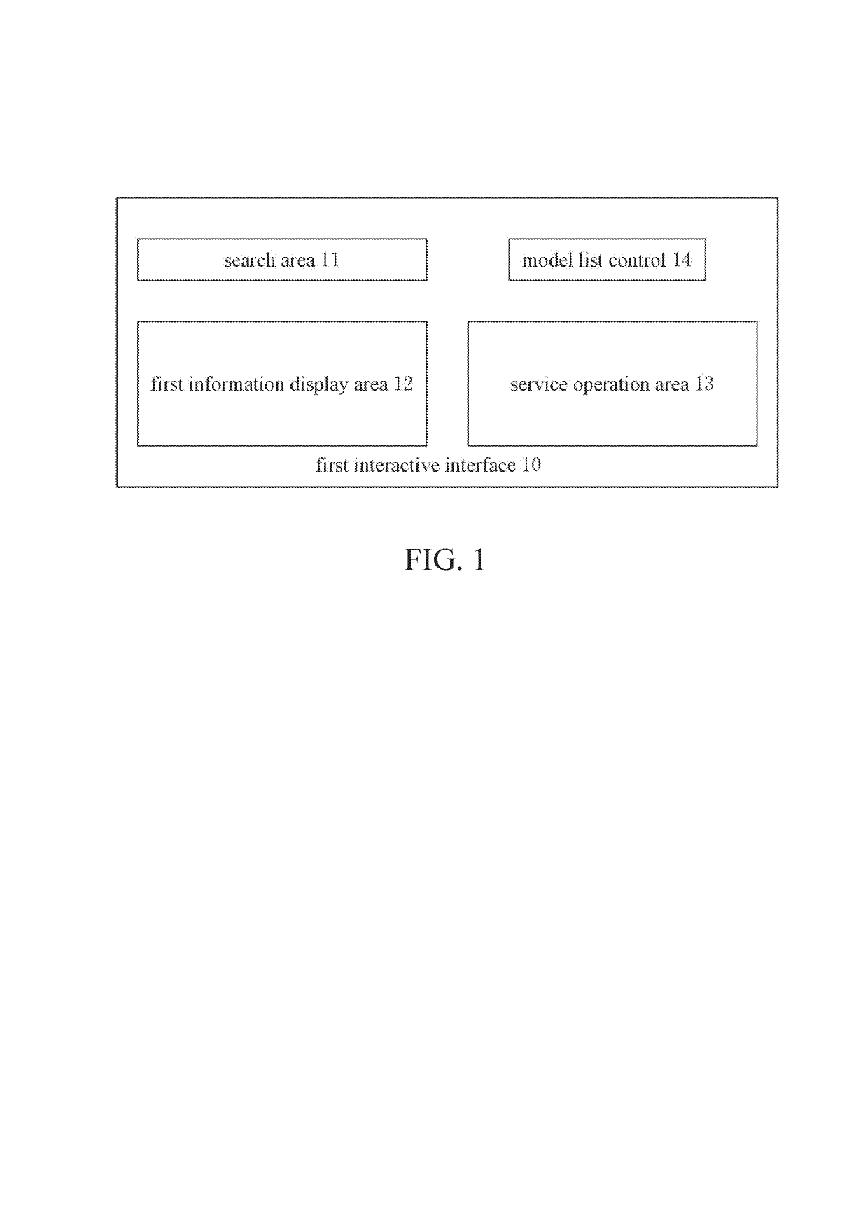

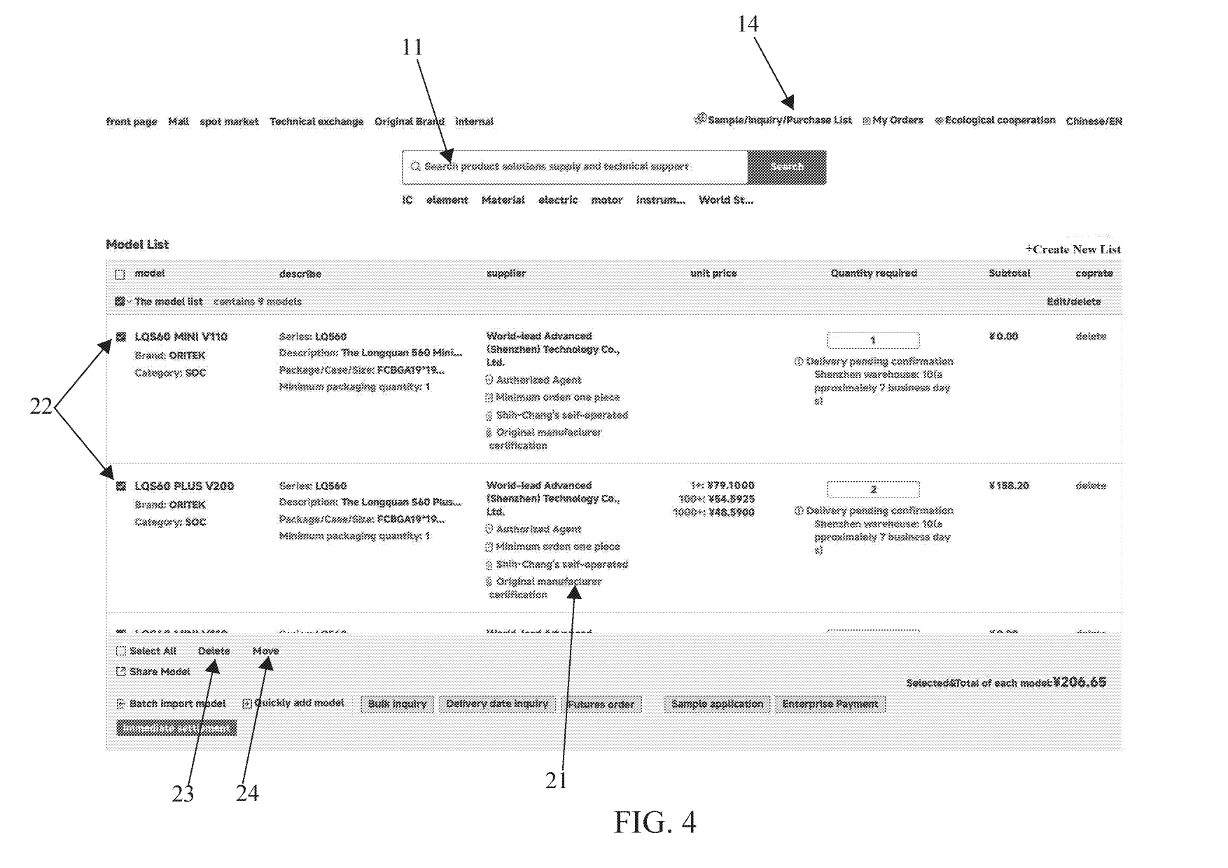

Further, in this embodiment, as shown in FIG. 1, the first interactive interface 10 also includes a model list control 14, which displays the quantity of items in the model list and enters the second interactive interface 20 based on a user's triggering operation. Specifically, as shown in FIG. 2, when a user clicks the "Model List" control in the upper-right corner, it can directly access the second interactive interface 20, as detailed in FIG. 4. After entering the second interactive interface 20, the model list control 14 remains displayed.

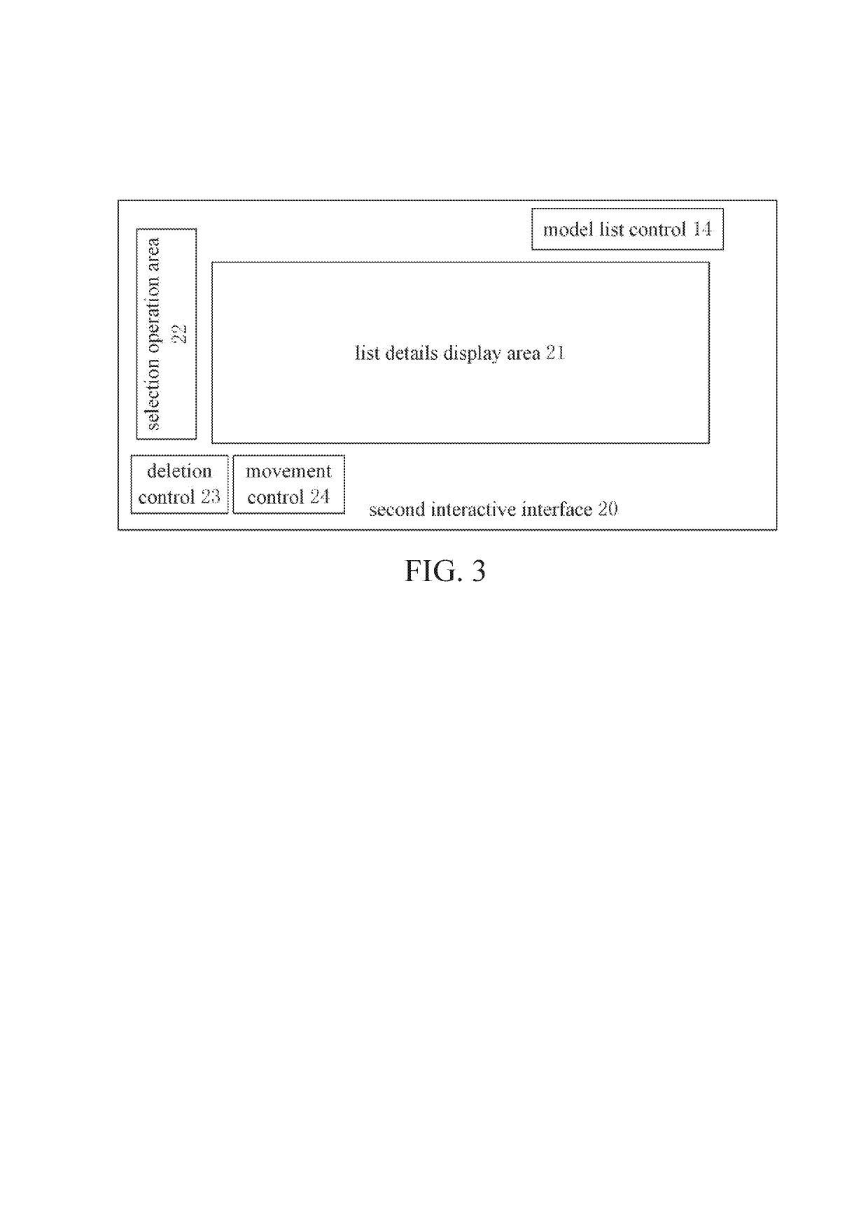

As shown in FIG. 3, in this embodiment, the second interactive interface 20 includes a list details display area 21 and multiple different second order operation controls. The list details display area 21 is configured to display product information for all models, while each second order operation control allows a user to perform order operations.

In this embodiment, the second order operation controls include, but are not limited to: a bulk inquiry operation control, a delivery query operation control, a sample application operation control, an enterprise procurement operation control, a small-quantity quick purchase operation control, a model selector/comparison table operation control, and a product details page operation control.

In this embodiment, by setting multiple second order operation controls on the second interactive interface 20, the purpose of connecting various key services of the platform (such as bulk inquiry, delivery date inquiry, sample application, enterprise procurement, small-quantity quick purchase, etc.) through the model list as a carrier is achieved. In other words, when the user selects any one or more models on the second interactive interface 20, the system executes the corresponding order operation service based on the selected models, thereby utilizing the model list to connect the models and services added in various scenarios and meeting the user's need to quickly initiate diversified services for a BOM list at different R&D stages.

Further, in this embodiment, as shown in FIG. 3, the second interactive interface 20 also includes: a second settlement control, which is configured to execute the settlement function for the selected models in the model list based on the user's triggering operation. Specifically, as shown in FIG. 4, when the user clicks the "Immediate settlement" control, the settlement function can be executed for the two models F002FF0300398 (source: product details page) and F002FF0300398 (source: small-quantity quick purchase). When the user clicks the "Bulk inquiry" control, the bulk inquiry service can be initiated for these two models.

Further, in this embodiment, the second interactive interface 20 also includes: a BOM list import control (not illustrated in FIG. 4), which is configured to import the material information from the BOM list based on the user's triggering operation and display the product information of all models in the imported material information through the list details display area 21. Specifically, by setting this BOM list import control, the various models and their related product information in the BOM list can be quickly imported into the model list, thereby rapidly determining the user's desired models and project needs (such as sample applications, inquiries for pricing and delivery dates, purchases, etc.). This achieves the purpose of managing the BOM list through the model list while also connecting services for a user at different R&D stages based on the model list, providing a user with convenient and quick service initiation (i.e., directly initiating services such as bulk inquiry, delivery date inquiry, sample application, and enterprise procurement on the model list interface shown in FIG. 4). In other words, the invention enables the application of different service resources for models in a single location, achieving centralized management of resource applications.

Further, as shown in FIG. 4, the second interactive interface 20 further includes: a selection operation area 22. The selection operation area 22 is configured for a user to perform selection or deselection operations on the models in the list details display area 21. The selection operation area 22 includes: selection controls placed before each model. When a user clicks the selection control before a model, the model is selected. When the user clicks the selection control before the model again, the model is deselected.

Further, as shown in FIG. 4, the second interactive interface 20 also includes: a deletion control 23 (such as the "Delete" button and "Move" button in the lower-left corner of FIG. 4) and a movement control 24. The deletion control 23 is configured for the user to perform deletion operations on the models in the list details display area 21. The movement control 24 is configured for the user to perform move operations on the models in the list details display area 21.

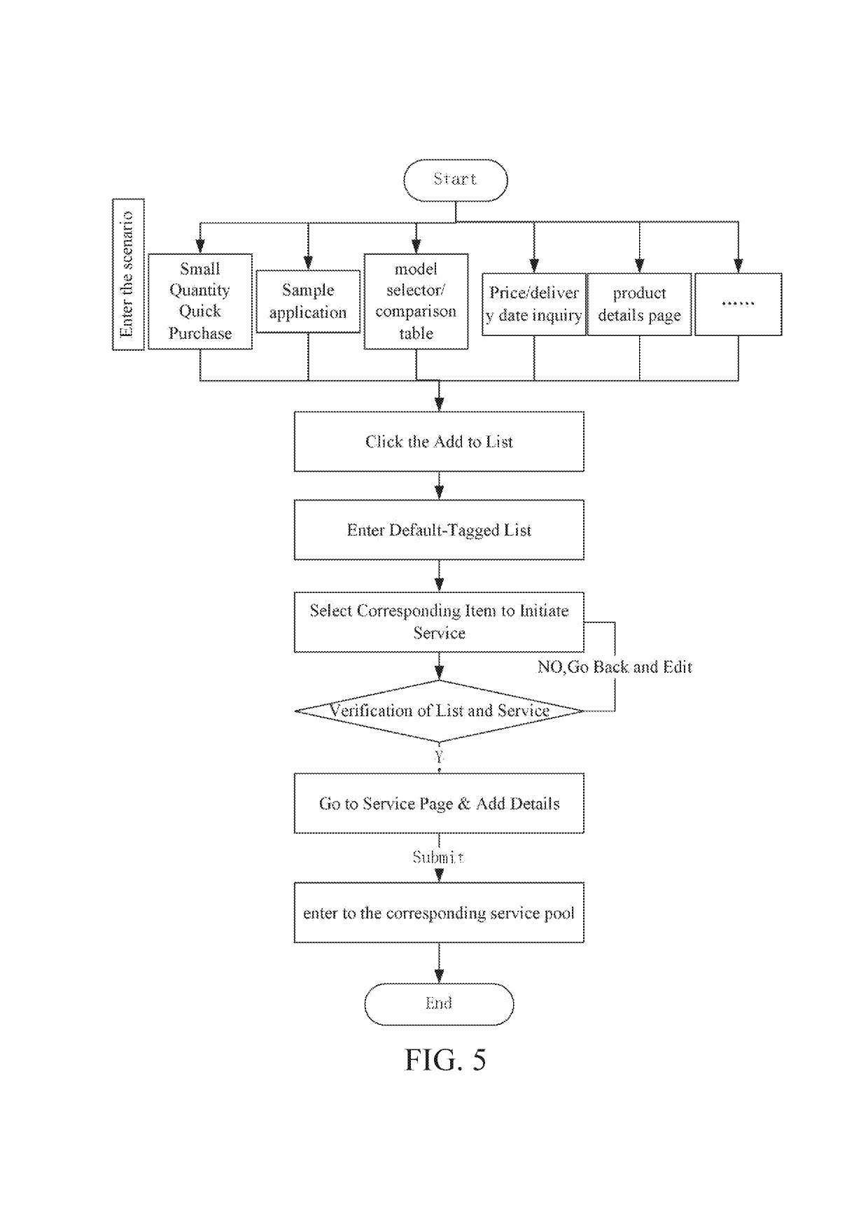

As shown in FIG. 5, it is a flowchart of a specific embodiment of the user order operation provided by the present invention.

As shown in FIG. 5, when the user inputs the desired model in the search area 11 of the first interactive interface 10, the system correspondingly obtains the product information of the desired model and displays it in the first information display area 12 for the user. Next, when the user selects any first order operation control in the service operation area 13, a first pop-up window 15 is displayed in the first interactive output. The first pop-up window 15 displays the product information of the desired model. When the user clicks the "Add to List" control in the first pop-up window 15, the first pop-up window 15 disappears, and the desired model input by the user is added to the model list shown in FIG. 4 (i.e., the list with the default identifier). When the user selects the corresponding product (i.e., the corresponding model in FIG. 4, such as F002FF0300398, source: Small Quantity Quick Purchase) and initiates a service (e.g., clicking the "Enterprise Procurement" control), the system performs validation based on the model list and service requirements (enterprise procurement) (specifically verifying the model, brand information, and purchase quantity). If the validation fails, the information is fed back to the user for corrections regarding the model, brand information, or purchase quantity. If the validation passes, the system redirects to the service page for the user to fill in other information (e.g., user identity information, procurement information, etc.). After the user completes filling in the other information and clicks the "Submit" control, the order request is sent to the server via the platform, and the server executes the order placement service based on the order request.

The various embodiments in this specification are described in a progressive manner, with each embodiment focusing on the differences from other embodiments. For identical or similar parts between the embodiments, cross-referencing may be applied. As for the devices disclosed in the embodiments, since they correspond to the methods disclosed in the embodiments, their descriptions are relatively brief, and relevant parts can be referred to in the method section.

Professionals may further recognize that the units and algorithmic steps of the examples described in the embodiments disclosed herein can be implemented in electronic hardware, computer software, or a combination of both. To clearly illustrate the interchangeability of hardware and software, the composition and steps of each example have been generally described in terms of functionality in the above description. Whether these functions are performed by hardware or software depends on the specific application and design constraints of the technical solution. Professionals may use different methods for each specific application to implement the described functions, but such implementations should not be considered beyond the scope of the present invention.

The steps of the methods or algorithms described in the embodiments disclosed herein may be directly implemented by hardware, software modules executed by a processor, or a combination of both. Software modules may reside in random access memory (RAM), internal memory, read-only memory (ROM), electrically programmable ROM (EPROM), electrically erasable programmable ROM (EEPROM), registers, hard disks, removable disks, CD-ROMs, or any other form of storage medium known in the technical field.

The above embodiments are provided solely to illustrate the technical concepts and features of the present invention, aiming to enable those skilled in the art to understand the content of the invention and implement it accordingly. They are not intended to limit the scope of protection of the invention. Any equivalent modifications or variations made within the scope of the claims of the present invention shall fall within the coverage of the claims.

What is claimed is:

1. A management system based on a product model list, wherein the system comprises a first interactive interface and a first pop-up window;
the first interactive interface comprises: a search area, a first information display area, and a service operation area; the search area is configured to receive a user-input desired model, the first information display area is configured to display product information of the desired model, and the service operation area is configured to allow a user to perform order operations for different needs and output the first pop-up window based on a user's order operation, wherein the first pop-up window displays the product information of the desired model according to the order operation triggered by the user;
the service operation area comprises: multiple different first order operation controls capable of meeting user needs, each of which is configured for the user to perform an order operation.

2. The management system based on a product model list according to claim 1 wherein the first pop-up window comprises: a second information display area, a purchase quantity input area, an open model list control, an add to list control, and a first settlement control; the management system further comprises: a second interactive interface;
the second information display area is configured to display the product information of the desired model;
the purchase quantity input area is configured for the user to input a purchase quantity of the desired model;
the open model list control is configured to enter the second interactive interface based on a user's triggering operation;
the add to list control is configured to add the desired model to the model list according to a user's triggering operation;
the first settlement control is configured to execute a settlement function for the desired model according to a user’s triggering operation.

3. The management system based on a product model list according to claim 2 wherein the first interactive interface further comprises: a model list control;
the model list control is configured to display the quantity in the model list and enter the second interactive interface based on a user's triggering operation.

4. The management system based on a product model list according to claim 2 wherein, after the add to list control receives a user's triggering operation, the first pop-up window is not displayed.

5. The management system based on a product model list according to claim 2 wherein, the second interactive interface comprises: a list details display area and multiple different second order operation controls;
the list details display area is configured to display product information of all models; each second order operation control is configured for a user to perform an order operation.

6. The management system based on a product model list according to claim 1 wherein, the first order operation control and the second order operation control each comprise: a bulk inquiry operation control, a delivery date inquiry operation control, a sample application operation control, an enterprise procurement operation control, a small-quantity quick purchase operation control, a model selector/comparison table operation control, and a product details page operation control.

7. The management system based on a product model list according to claim 6 wherein, the second interactive interface further comprises: a second settlement control;
the second settlement control is configured to execute a settlement function for selected models in the model list based on a user's triggering operation.

8. The management system based on a product model list according to claim 5 wherein, the second interactive interface further comprises: a BOM list import control;
the BOM list import control is configured to import material information from the BOM list based on a user's triggering operation and display product information of all models in the imported material information through the list details display area.

9. The management system based on a product model list according to claim 5 wherein the second interactive interface further comprises: a selection operation area;
the selection operation area is configured for a user to perform selection or deselection operation on the models in the list details display area.

10. The management system based on a product model list according to claim 5 wherein, the second interactive interface further comprises: a deletion control and a movement control;
the deletion control is configured for a user to perform a deletion operation on the models in the list details display area;
the movement control is configured for a user to perform a movement operation on the models in the list details display area.

11. The management system based on a product model list according to claim 5 wherein, the first order operation control and the second order operation control each comprise: a bulk inquiry operation control, a delivery date inquiry operation control, a sample application operation control, an enterprise procurement operation control, a small-quantity quick purchase operation control, a model selector/comparison table operation control, and a product details page operation control.

12. The management system based on a product model list according to claim 11 wherein, the second interactive interface further comprises: a second settlement control;
the second settlement control is configured to execute a settlement function for selected models in the model list based on a user's triggering operation.
